(19) United States
(12) Patent Application Publication
(10) Pub. No.: US 2024/0001605 A1
(43) Pub. Date: Jan. 4, 2024

(54) Throttle Unit

(71) Applicant: Eugen Seitz AG, Wetzikon (CH)

(72) Inventors: Manuel Keel, Wildegg (CH); Marco Erni, Buttwil (CH)

(21) Appl. No.: 18/346,323

(22) Filed: Jul. 3, 2023

(30) Foreign Application Priority Data
Jul. 4, 2022 (EP) 22182744.7

(51) Int. Cl. B29C 49/42; B29C 49/78; B29C 49/58

(52) U.S. Cl. CPC B29C 49/4289; B29C 49/783; B29C 49/58

(57) ABSTRACT

A throttle unit, in particular of a blow moulding device, includes a throttle and a position sensor. The throttle has an actuator and a drive unit including an electric motor for changing a position of the actuator. A throughflow cross section in a throughflow channel of a fluid can be changed by changing the position of the actuator. The drive unit is arranged at a first end of the actuator. The position sensor monitors the position of the actuator directly. The throttle unit makes it possible to set and adjust the throttle automatically in an accurate but nevertheless cost-effective manner.

### CROSS REFERENCE TO RELATED APPLICATION

This application claims priority to European Patent Application No. 22 182 744.7 filed Jul. 4, 2022, the disclosure of which is hereby incorporated by reference in its entirety.

### BACKGROUND OF THE INVENTION

### Field of the Invention

The present invention relates to a throttle unit and to a device comprising a throttle unit, in particular a blow moulding device. The throttle unit is suitable in particular for use in an extrusion blow moulding machine or a stretch blow moulding machine for the manufacture of hollow bodies made of plastics material.

### Description of Related Art

Blow moulding equipment or blow moulding machines act to mould hollow bodies, in particular for the production of plastics material bottles made of PP (polypropylene) or PET (polyethylene terephthalate). Conventionally, a pre-heated preform is connected to a blowing nozzle of the blow moulding machine. The preform is expanded by injecting a process gas, preferably compressed air. The desired shape can be achieved by using blow moulds.

The individual blowing steps are controlled by means of valves, which are subject to stringent requirements. During the blowing process, the process gas, conventionally blowing air, is introduced at different pressures. Therefore, the blowing air used during the pre-blowing procedure is at a lower pressure, for example 10 bar, than during the main blowing procedure, for example 40 bar. The main blowing procedure can also be carried out in several stages at different pressures. Separate valves are therefore used for each step of the blowing process, wherein throttles are provided in order to adapt the volume flow rate or the pressure increase of the blowing air, at least in the pre-blowing phase and thus at least for the pre-blowing valves. A throughflow cross section is set by the throttle. The size of the cross section is set based on various parameters, such as the material of the preform, the wall thickness of the preform and the temperature of the preform. This throttle setting is conventionally retained during operation. However, the cross section is reset or adjusted when there is a change in the type of hollow body to be produced, and also as the throttle or other components of the blow moulding device age. The setting and adjustment procedures are conventionally performed manually in the prior art.

Preferably, each valve block has at least one throttle, i.e. at least one separate throttle is associated with each station for receiving a hollow body to be inflated. Therefore, depending on the size of the system, up to 36 throttles are arranged on a blowing wheel.

Setting such a large number of throttles manually is therefore time-consuming and susceptible to errors. It is virtually impossible to perform manual readjustment or regulation during ongoing operation of the blow moulding device.

EP 3 063 441 B1 discloses a motor-operated throttle, in which the actuator is sealed relative to an outer housing.

EP 3 541 599 B1 discloses a spring-loaded proportional valve comprising a proportional solenoid as a drive, a Hall sensor as a position sensor and a pressure sensor for monitoring the fluid pressure. The Hall sensor measures the position of the armature of the proportional solenoid.

EP 2 669 069 B1 shows a control valve comprising a throttle element and a distance sensor for determining the position of the throttle element. The position of the throttle element is set by a control on the basis of the measured position and the pressure of the blowing fluid.

EP 2 977 184 B1 proposes a device without throttle valves of this type for reducing the blowing pressure in the pre-blowing phase. The device uses a control valve which is set on the basis of a control signal. The control valve is not described in detail. However, activating a control valve of this type, which is intended to regulate the pressure for the pre-blowing and main valves, is complex and, accordingly, cost-intensive.

### SUMMARY OF THE INVENTION

It is therefore an object of the invention to provide a throttle unit and a device comprising a throttle unit which make it possible to set and adjust the throttle automatically in an accurate and yet cost-effective manner.

The throttle unit according to the invention is suitable for use in a blow moulding device, for example in an extrusion blow moulding machine or a stretch blow moulding machine for manufacturing hollow bodies made of plastics material, in particular plastics material bottles made of PET or PP.

The throttle unit has a throttle and a position sensor. The throttle has an actuator and a drive unit comprising an electric motor for changing a position of the actuator, wherein a throughflow cross section in a throughflow channel of a fluid can be changed by changing the position of the actuator. The drive unit is arranged at a first end of the actuator. According to the invention, the position sensor directly monitors the position of the actuator.

This makes it possible to determine the position of the actuator accurately.

Directly monitoring the actuator makes it possible to use a cost-effective electric motor to alter the setting of the actuator. In particular, a simple direct current motor, also referred to as a DC motor, can be used. The electric motor can be configured to be small and can have a multi-stage gear mechanism and a relatively large amount of backlash.

The direct monitoring also includes the monitoring of an element, which is rigidly connected to the basic structure of the actuator, moves together with the actuator and is monitored itself instead of the actuator. Due to the rigid connection, this element is to be understood as an integral part of the actuator. This can, for example, take the form of a pointer arranged on the actuator or a rigid, projecting vane.

The throttle unit can thus be integrated into a valve block of the blow moulding device. The throttle and the drive unit can also be constructed as a single component, i.e. a module. The entire module can be installed in and removed from the valve block or at the place of use thereof in a simple manner. This is advantageous in particular in respect of valve blocks, as space is limited in blow moulding devices.

Preferably, the housing of the valve block itself acts as the housing for the module, i.e. the actuator is arranged directly in the throughflow channel of the valve block, and the electric motor is not protected by its own closed housing. Since the valve block can act as the motor housing, it is not necessary to observe any further specific requirements as to hygiene and impermeability.

Preferably, the component substantially takes the form of an elongate circular cylinder which can be inserted into a hole in the valve block. This simplifies the replacement of this consumable.

The throttle can be set electronically thanks to the use of a position sensor. In preferred embodiments, the setting can be altered both when in a non-operational state and also during operation. Depending on the embodiment, the setting can be changed between two blowing processes or even during the blowing process. Consequently, the throttle setting can be regulated in accordance with process data, for example based on a pressure increase curve. Process data can be obtained for example by sensors which monitor the pre-blowing and/or main blowing valves or the blowing pressure in the region of the preform or the change in shape of the preforms.

Preferably, the position data measured are sent to a control unit. This increases process reliability because the actual position of the actuator is known. In addition, the control unit can change the position of the throttle on the basis of these measured position data and in accordance with control values of a machine control or in an independent manner.

It is therefore possible to ensure, in a simple manner, that all stations have a correct throttle setting. The throttle settings can be changed by means of the control unit. Manual setting procedures at individual stations are unnecessary, and therefore setting the throttle units is considerably more efficient. It is also possible to automate the setting procedure by means of the control unit of the valve block and/or the machine control.

If it is possible to carry out an adjustment and/or regulation during operation of the blow moulding device, a relatively consistent standard of container quality can be obtained. The defect rate can also be reduced. Depending on the embodiment, the adjustment or regulation is performed manually at an input unit of the machine control or the control unit of the valve block. In other embodiments, this is carried out via an input unit of the machine control.

The throttle unit is preferably only used to set a default setting of the volume flow rate or pressure increase in the blowing process, wherein the default setting remains in principle unchanged during a blowing process. In some cases, minor, non-time-critical changes to the position of the actuator are also made between individual blowing cycles. Therefore, relatively slow movement of the throttle is sufficient in comparison with the switching times of the pre-blowing and main blowing valves. The above-mentioned simple and thus cost-effective DC gear motor is sufficient for the intended purpose.

Preferably, the throttle unit acts to set the pre-blowing pressure. If different blowing pressures are also to be used in the main blowing process, further throttle units according to the inventive principle can be used.

The combination according to the invention of the arrangement of the position sensor and the closed end of the actuator can also be used in throttle units, in particular in control valves, in which the actuator is adjusted to carry out the process, i.e. the process pressure or the fluid volume flow rate is changed by means of the actuator in order to operate the device. Preferably, however, the throttle unit acts exclusively to set and regulate a default setting of the process pressure or the fluid volume flow rate, as explained above.

The throttle unit according to the invention can also be used in other devices. The concept of the invention is not limited to blow moulding devices.

The position sensor is preferably arranged in the region of a second end of the actuator opposing the first end. This simplifies the cylindrical configuration of the throttle. In this case, the position sensor can be oriented towards the actuator in the radial direction thereof. Preferably, however, it is arranged at an end face.

Preferably, the actuator has a flow channel through which fluid can flow, wherein the actuator is configured to be closed at the second end relative to the flow channel. This facilitates the arrangement of the position sensor, since the fluid thus leaves the throttle unit in a radial direction and not at an end face.

The first end and the second end preferably define a longitudinal centre axis, wherein the actuator is rotatable about the longitudinal centre axis. Depending on the embodiment, the actuator moves along the longitudinal centre axis, wherein, depending on the embodiment, a rotational movement is additionally superimposed. In preferred embodiments, the actuator rotates or pivots about the longitudinal centre axis only, without any movement in the longitudinal direction. It is thus stationary in the direction of the longitudinal centre axis, wherein the position sensor is also preferably arranged so as to be stationary in the longitudinal direction after the actuator.

Different types of position sensor can be employed, such as optical or capacitive sensors. Preferably, however, the position sensor is a magnetic field sensor, in particular a Hall sensor. These position sensors are relatively small and are reliable.

If a magnetic field sensor is used, a magnet or magnetisable element is preferably arranged in the throttle, preferably in the actuator.

In preferred embodiments, the magnet is a permanent magnet. The permanent magnet is preferably manufactured from a hard magnetic material. In other embodiments, the magnet is an electromagnet and is used in combination with a magnetisable element.

The magnetisable element is preferably manufactured from a soft magnetic material, and more preferably from a magnetically conductive material with low remanence, and particularly preferably from a magnetically conductive material with extremely low remanence.

If a magnetisable element is provided, an associated magnet, in particular a permanent magnet or an electromagnet, is preferably arranged so as to be stationary, preferably adjacent to the position sensor.

The magnet or magnetisable element is preferably arranged adjacent to the position sensor. Preferably, the magnet or magnetisable element is arranged in or at an end region of the throttle.

Depending on the embodiment, the magnet is a bar magnet or a disc magnet. The magnet, with the axis thereof defined by the north and south poles thereof, is preferably arranged perpendicularly to a rotational axis of the actuator, so that rotation of the actuator brings about a change in the magnetic field detected by the position sensor. Preferably, the magnet is arranged centrally relative to the longitudinal axis of the throttle. Eccentric arrangements are also possible.

Tolerances in the orientation of the magnet or magnetisable element relative to the sensor can be compensated for example by determining an angle error in a conventional manner. The angle error details can be stored in the control and taken into account when the throttle is used. The information relating to angle errors can be entered separately into the control. Preferably, however, it is stored during production on a storage element, for example on an RFID tag. The storage element is preferably arranged on or in the throttle unit and is preferably rigidly connected thereto. Consequently, when the throttle unit is used, the storage element can be read by the control unit and uniquely identified with the throttle unit. Further data which can be utilised by the control unit or the machine control can be stored on the storage element. Data of this type are, for example, the characteristic curve of the throttle or information relevant to service life, some of which are only generated once operation has commenced, such as cycles or angular degrees to be travelled or already travelled.

Alternatively or in addition, the magnet or magnetisable element can also be positioned extremely accurately. This is achieved, for example, by fastening, in particular adhesively bonding or encapsulating, the magnet or magnetisable element in an oriented manner. In this case, the exact vector of the magnet is determined by a measuring system and the receiving opening, which receives the magnet in the actuator, is configured accordingly.

Alternatively or in addition, an indicator, for example in the form of a cam or a notch, which acts as a mechanical stop, can also be fitted in the actuator. In a reference run, the electric motor travels to this stop at reduced power. The increase in current in the electric motor when the stop is reached is detected and this position is stored as the starting position, i.e. as the “0” position.

Therefore the zero position of the actuator can preferably be accurately identified for each throttle unit, either by already compensating for the magnet error during manufacture or by determining it for a completed throttle unit and taking it into account in a control.

The actuator can be designed in various ways. Preferably, it has openings and/or recesses through which fluid flows and which thus form a flow channel. These openings and/or recesses can be configured at different locations on the actuator. In a preferred exemplary embodiment, however, they are all located at a distance from the second end of the actuator.

Depending on the embodiment, the actuator changes the throughflow cross section in steps or continuously, i.e. in a stepless manner. Continuous adjustability is preferred.

In a particularly preferred embodiment, the actuator has a basic structure in the form of a circular cylinder comprising a winding indentation which is configured to be open to the exterior. This shape makes it possible to achieve a uniform change in the volume flow rate over a relatively large actuating angle.

This actuator therefore makes it possible to achieve continuous adjustment in a simple manner. In addition, the actuator can be produced in a simple manner. Since the actuator does not have any through-openings for the fluid, there is also sufficient space to connect the actuator directly to a motor axle of the electric motor and to arrange the magnet or magnetisable element. The actuator can thus be configured to be relatively small.

In preferred embodiments, the winding indentation has a development consisting of legs and a web connecting the two legs to each other. Preferably, the two legs of the development extend approximately parallel to each other.

This makes it possible to use a wide actuating angle range of approximately 300°. This simplifies the allocation of actuating angles to flow rates or flow resistance. The actuating angle can be utilised to the full and the precision of the throttle is increased. Moreover, cost-effective and less precise electric motors can therefore be used.

Preferably, the two legs of the development extend perpendicularly to the longitudinal centre axis of the actuator. As a result, the angle of approach of the fluid flowing through is perpendicular to the piston-like actuating angle.

Due to this configuration of the actuator with the above-mentioned development, the throttle unit is also relatively resilient to axial displacements of the actuator.

Due to the winding indentation and in particular when the indentation is configured as described above, the fluid flowing through generates little or no torque on the longitudinal axis of the actuator and thus on the motor axle of the electric motor. The motor of the throttle is thus subject to fewer stresses and ages more slowly. It can be used for a relatively long period of time.

The actuator comprising the winding indentation, in particular with a development in the form of two legs with a web connecting the legs to each other, more particularly with a development having two legs which extend in a parallel manner, preferably perpendicularly to the longitudinal centre axis and thus to the rotational axis of the actuator, is claimed herein as an independent invention, even without a position sensor and/or without a direct connection to the electric motor.

This actuator is advantageous in that the shape of the development of the indentation can be selected depending on the intended use of the throttle. In this way, a throttle unit can be produced for which a different flow channel shape can be employed selectively and based on client specifications. This minimises production costs and maximises flexibility in the design of the throttle.

The actuator can be constructed in a plurality of pieces. Preferably, however, it is constructed in one piece. This facilitates production and connection with the drive unit.

In preferred embodiments, the drive unit has a motor shaft which is dynamically sealed. The motor shaft is, in this case, preferably directly connected to the actuator. Preferably, the dynamic seal of the motor shaft is the only dynamic seal for sealing the throttle relative to an outer housing which receives the throttle. This seal thus has a very small diameter. This is advantageous since frictional forces, which have a negative effect on the torque, are consequently kept very low. Due to the small dynamic seal, the axial forces which could be transferred to the electric motor are also kept very low, and therefore the motor operates in a relatively precise manner and can be used for a relatively long period of time.

Axial forces can be neutralised or at least further reduced by sealing the actuator, in particular the cylindrical actuator in a symmetrical manner at both end faces, for example by arranging a counter pin at the opposing second end. This is implemented in further embodiments.

The idea of dynamically sealing the motor shaft in a throttle comprising an actuator and a drive unit is claimed herein as an independent invention, even without a position sensor.

In particular, this idea can also be used with a powerful, zero-backlash motor, for example a brushless DC motor or a stepper motor. This makes it possible to achieve a proportional throttle which, for example, makes it possible to readjust the pressure curve.

The device according to the invention has the above-described throttle unit and an outer housing comprising the duct channel. The outer housing is preferably a valve block of a blow moulding device. The actuator is arranged in the duct channel, wherein the duct channel has an inlet opening for supplying the fluid into the flow channel of the actuator and an outlet opening for guiding the fluid away from the flow channel of the actuator. The inlet opening and the outlet opening are arranged transversely to the longitudinal centre axis of the actuator.

This enables the actuator to be directly connected to the motor axle in the longitudinal direction of the actuator and thus enables the throttle to be configured as a module which can be arranged in its entirety, i.e. including the electric motor, in the outer housing. For this purpose, the outer housing preferably has a hole for receiving the throttle unit, wherein a portion of the hole forms a portion of the duct channel.

Preferably, the throttle, at the end thereof remote from the actuator, has a flange which acts to fix the module in the outer housing. The module can be fixed with a single screw, and therefore can be installed and replaced in a very simple and rapid manner.

### BRIEF DESCRIPTION OF THE DRAWINGS

The terms Fig., Figs., Figure, and Figures are used interchangeably in the specification to refer to the corresponding figures in the drawings.

Preferred embodiments of the invention are described in the following with reference to the drawings, which are provided for illustrative purposes only and are not to be interpreted as restrictive. In the drawings:

FIG. 1 shows a perspective view of a valve block of a blow moulding device comprising the throttle unit according to the invention, wherein the valve block is shown in partial section,

FIG. 2 shows a perspective view of a position sensor of the throttle unit according to the invention as shown in FIG. 1,

FIG. 3 shows a schematic view of the throttle unit according to the invention in a first combination with a device,

FIG. 4 shows a schematic view of the throttle unit according to the invention in a second combination with a device,

FIG. 5 shows a partial section through a portion of the valve block as shown in FIG. 1 with a fitted throttle unit according to the invention,

FIG. 6 shows a perspective view of the throttle unit as shown in FIG. 1,

FIG. 7 shows a longitudinal section through the arrangement as shown in FIG. 5,

FIG. 8 shows a longitudinal section through a valve block with a fitted throttle unit according to the invention in a further embodiment,

FIG. 9 shows an actuator of the throttle unit according to the invention as shown in FIG. 7,

FIG. 10 shows the actuator as shown in FIG. 9 with a view of the development of the indentation thereof,

FIG. 11 shows an actuator of the throttle unit according to the invention in a second embodiment,

FIG. 12 shows an actuator of the throttle unit according to the invention in a third embodiment, and

FIG. 13 shows a portion of the throttle unit according to the invention with a fitted storage element.

### DESCRIPTION OF PREFERRED EMBODIMENTS

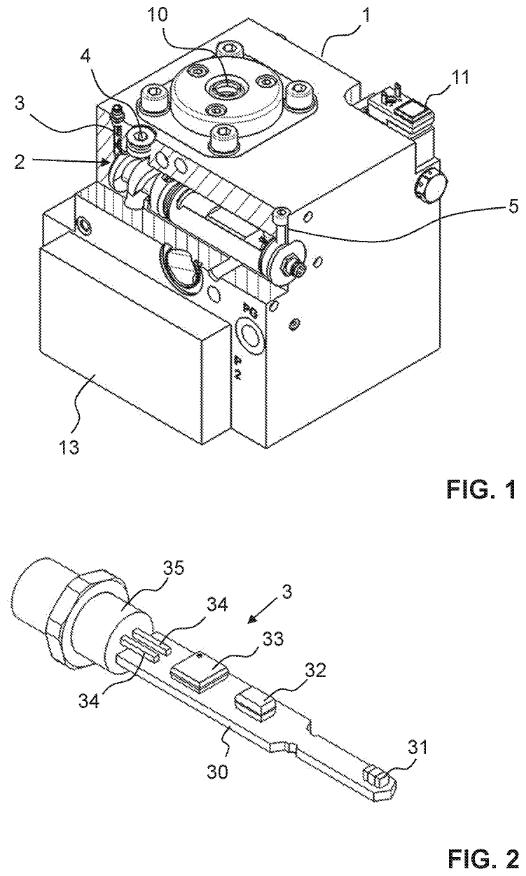

FIG. 1 shows a preferred field of application of the throttle unit according to the invention. The field of application is a housing block of a blow moulding machine, also referred to as a valve block. The valve block 1 has a through-hole 10 which is penetrated by a blowing pin. A blank of a body to be inflated, in particular a PET or PP bottle, can be arranged on or in the through-hole 10. Blow moulding machines of this type are widely known in the prior art and will therefore not be described in greater detail.

They have a plurality of process valves which are actuated at different times during the course of the blowing process in order to bring the blank into the desired shape by means of blowing air. In this view, a pilot valve 11 of a process valve is shown. Further process valves, more specifically a pre-blowing valve and a main blowing valve, are covered by a valve cover 13 and are therefore not visible in this figure.

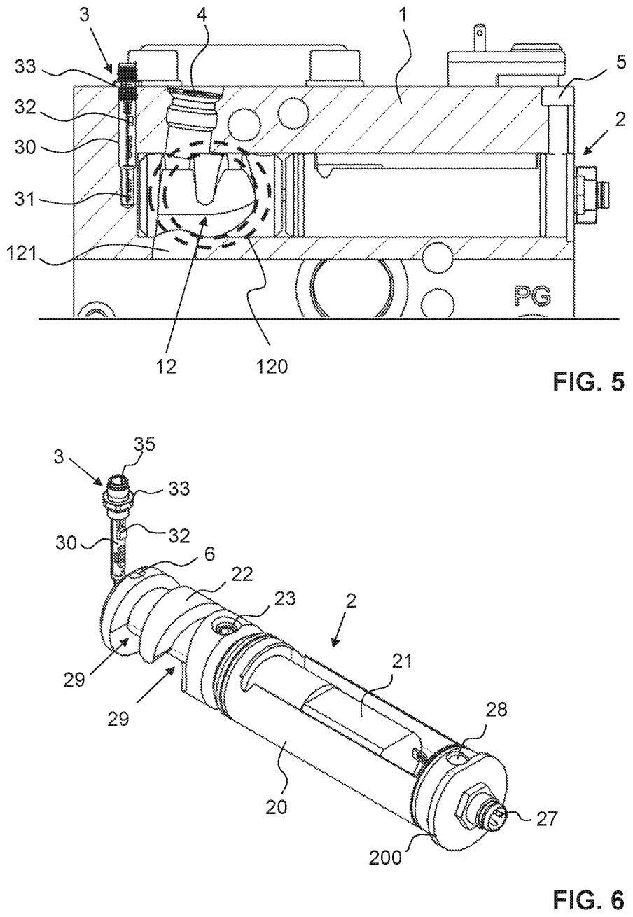

A process fluid, in this case blowing air, can be guided into the valve block from the exterior via a throughflow channel 12. The portion of the throughflow channel 12 located between an inlet opening 120 and an outlet opening 121 in the region of the throttle 2 is shown in FIG. 5.

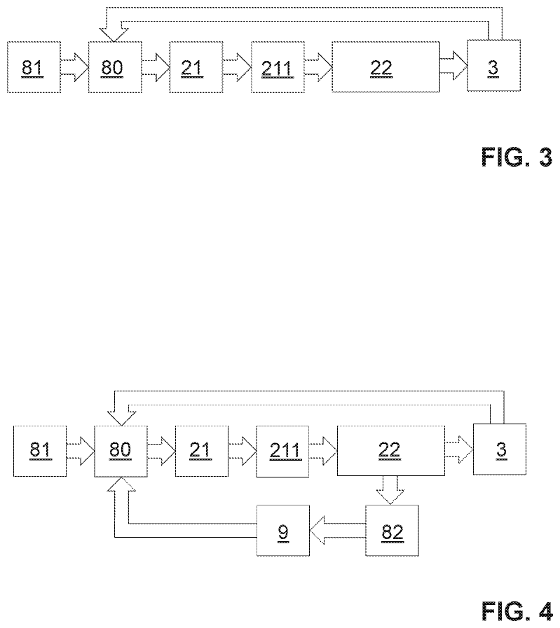

The valve block 1 is connected so as to be able to communicate with a control unit 80, which is connected to a machine control 81. The control unit 80 and the machine control are shown schematically in FIGS. 3 and 4.

A throttle unit according to the invention is arranged on or, as shown in this case, in the valve block 1. It comprises a throttle 2 and a position sensor 3.

The throttle 2 is configured to be substantially cylindrical and is introduced or inserted into a hole in the valve block 1. The casing of the throttle 2 is completely surrounded by the valve block 1. In FIG. 1, the valve block 1 is shown in a sectional view in this region so that the throttle 2 can be seen. In the actual valve block 1, only the end shown on the right in FIG. 1 can be seen from the exterior.

The position sensor 3 is arranged adjacent to the throttle 2 in the valve block 1. In this example, it is arranged at an end face of the throttle 2. A sealing blanking plug 4 closes a hole in the valve block 1, which leads to the throttle 2, from the exterior.

A fastening screw 5 fixes the throttle 2 at an end of the throttle 2 opposing the position sensor 3.

A preferred exemplary embodiment of a position sensor 3 is shown in FIG. 2. It preferably has an elongate shape. Consequently, it requires little space and can be inserted into a hole in the valve block 1 in a simple manner. The position sensor 3 can be configured without a housing, since the valve block 1 forms the protective housing thereof. The position sensor 3 has a preferably flat base plate 30, at the front free end of which a magnetic field sensor, preferably a Hall sensor 31, is arranged. Instead of a Hall sensor, other sensors can also be used, for example a magnetoresistive sensor.

As shown in FIG. 2, further elements can be arranged on the base plate 30. Preferably, a storage means 32 is provided in order to store measured values, but also correction values, locally. Preferably, an electronic unit 33 is provided in order to operate the magnetic field sensor and to transmit the measured values to the control unit 80.

At an end opposing the Hall sensor, the position sensor 3 has a plug connector 35 which is soldered onto the base plate 30 with a plug connector connection 34. The plug connector 35 protrudes from the valve block and acts as a second support point on the one hand and for connection to the control unit 80 on the other. The position sensor 3 is preferably releasably arranged in the valve block 1.

The throttle 2, more specifically an actuator 22 described below, constricts a throughflow cross section in the throughflow channel 12 and thus changes the throughflow volume. The position sensor 3 monitors the position of the throttle 2. More specifically, the position sensor 3 monitors the actuator 22 and thus determines the exact position thereof. The position of the actuator 22 is changed by means of an electric motor 21, which preferably has a gear mechanism 211.

An example of the manner in which the throttle unit can be operated and used is explained with reference to FIGS. 3 and 4.

A machine control 81, preferably a programmable logic controller (PLC), communicates with a control unit 80, also referred to as a control box. The control unit 80 acts on the electric motor 21 of the throttle 2 which, via an optional gear 211, changes the position of the actuator 22 of the throttle 2. This change is detected by the position sensor 3. The position sensor 3 reports the changed position to the control unit 80. Based on these reported data, and optionally in accordance with the machine control 81, the control unit changes the control data of the electric motor 21 and thus the position of the actuator 22. This is preferably carried out when resetting the process device, in particular the blow moulding machine, for example when a new type of hollow body is to be inflated or when the throttle 2 or another consumable part of the device ages or has been replaced. In this case, the machine control 81 preferably specifies a desired angle of the throttle 2.

In the variant shown in FIG. 4, regulation is also carried out during the production process. This is, however, preferably carried out exclusively between the switching cycles of the individual process valves, i.e. there is pressure in the throughflow channel 12, but the process fluid is not flowing.

For this purpose, a pressure sensor 9 is preferably provided, which measures the process pressure in the process 82, for example in the region of the preform. In this case, the machine control 81 preferably specifies a desired pressure or a desired pressure increase. The control unit automatically adapts the angle of the throttle 2 during the next blowing cycle, based on the information specified and taking into account the measured position of the actuator 22 and the pressure value of the pressure sensor 9. Preferably, regulation is not constant, and changes are rather only made between the blowing cycles in the event of divergence from desired values. In this way, a cost-effective electric motor, which has a sufficiently long service life due to the low number of switching cycles, can be used in the throttle 2.

A preferred exemplary embodiment of the throttle unit according to the invention is clearly shown in FIGS. 5 to 8.

The throttle 2 comprises the actuator 22 and a drive unit comprising a housing 20 and the electric motor 21. The housing 20 is preferably configured to be open at the top so that it forms a trough for receiving the electric motor 21. In other embodiments, the housing 20 is configured to be closed over the entire circumference thereof. The housing 20 is preferably configured in one piece. The actuator 22 is arranged at a front end, in the direction of insertion into the valve block 1. The actuator 22 and the housing 20, which is notionally completed to form a closed cylinder, preferably have an identical or an approximately identical outer diameter. The outer diameter is preferably only slightly smaller than the inner diameter of the hole in the valve block 1.

The right end of the housing 20 remote from the actuator 22 forms a flange 200 which acts as an external stop on the valve block 1. The fastening screw 5 fixes this end, and thus the throttle 2, in the hole in the valve block 1. For this purpose, the fastening screw 5 is received in an opening 28, shown in FIG. 6, in the region of the housing 20 adjacent to the flange 200.

An adjoining outer sealing ring 26 seals the throttle 2 from the exterior. The flange 200 is penetrated by a plug connector 27 which connects the electric motor 21 to the control unit 80.

The actuator 22 is likewise configured to be substantially cylindrical. It forms a flow channel 29 between an inlet opening 120 and an outlet opening 121 of the throughflow channel 12. This is clearly shown in FIG. 5. The portion of the throughflow channel 12, from the end shown leading to the exterior up to the inlet opening 120, is not visible due to the partial section in FIG. 1 and the sections shown in FIGS. 5, 7 and 8. It can, however, extend as desired within the valve block 1.

The actuator 22 is directly connected to a motor axle 210 of the electric motor 21. The fixing means used is preferably a grub screw 23.

The motor shaft 210 is dynamically sealed relative to the housing 20 by means of a sealing ring 25. Preferably, this is the only dynamic seal relative to the valve block or stationary components. An inner seal 24 seals the front end of the housing 20 facing the actuator 22 relative to the valve block 1.

The actuator 22 itself is not sealed. However, a sealing ring (shown in broken lines) is provided at the inlet opening 120 and a sealing ring (not shown) is provided at the outlet opening 121.

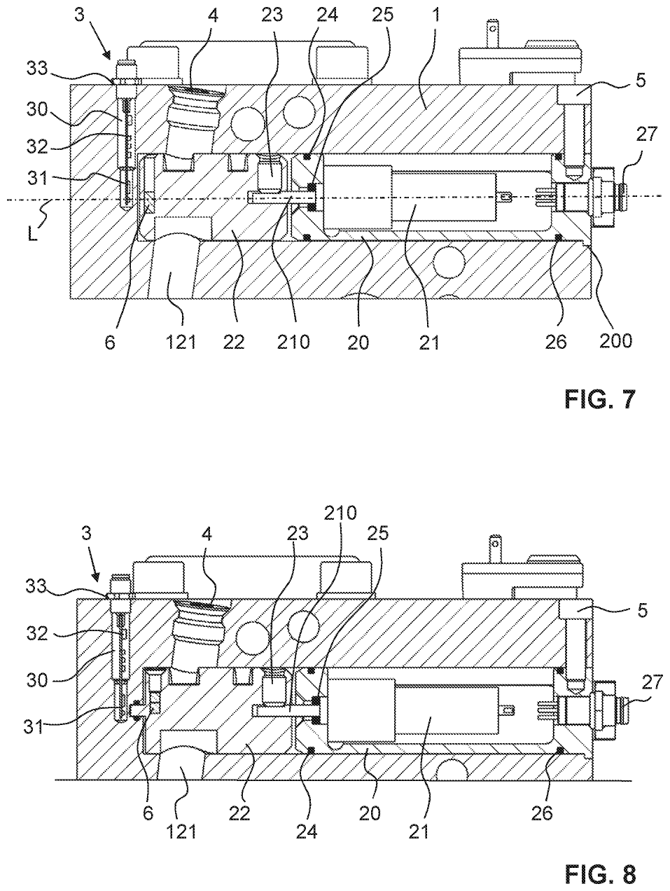

A magnet 6, preferably a permanent magnet, is arranged at the end of the actuator 22 facing away from the electric motor 21. In the examples shown in FIGS. 7 and 8, the magnet is a bar magnet which extends perpendicularly to the longitudinal centre axis L of the throttle 2. The magnet is arranged adjacent to the position sensor 3, wherein it is inserted into a hole arranged in the actuator 22 so that it is located adjacent to the end face of the actuator 22.

The magnet 6 is preferably arranged centrally relative to the longitudinal centre axis L, wherein the axis thereof, defined by the north and south poles thereof, extends perpendicularly to the longitudinal centre axis. If the actuator 22 is rotated about the longitudinal centre axis L by means of the electric motor 21, the magnetic field of the magnet 6 detected by the Hall sensor 31 changes and the change in the angle of rotation of the actuator can be detected. If a zero position of the actuator 22 is known, the effective angle of rotation, and thus the change in the throughflow cross section, can be calculated. The zero position of the angle of rotation is preferably a position in which the throughflow cross section is fully open or fully closed.

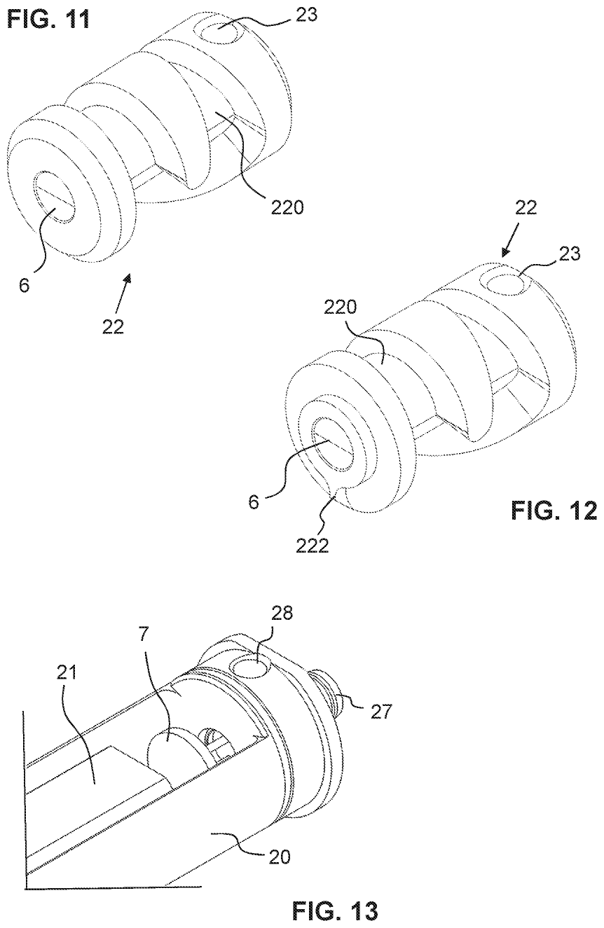

In other embodiments, the magnet 6 is a disc magnet, as shown in FIG. 11. In the figures, the dividing line within the magnet shows the north and south poles of the magnet 6. The measurement principle remains fundamentally the same. It is also possible to use other magnet shapes.

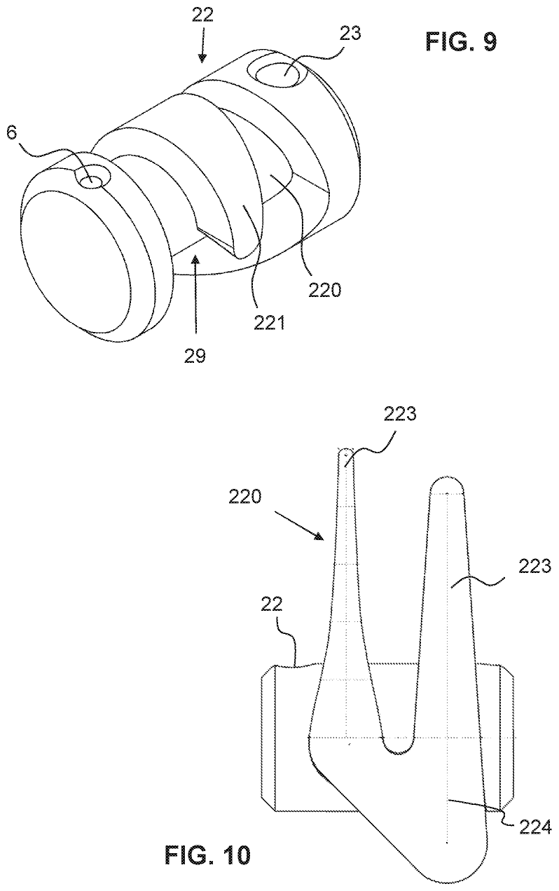

As is clearly shown in FIGS. 9 and 11, the actuator 22 is preferably configured in one piece. It has a substantially cylindrical basic structure, of which the end face facing the position sensor 3 is configured to be closed. This end face can have an indentation for the magnet 6, as illustrated in the embodiments shown in FIGS. 11 and 12. It is, however, preferably always closed relative to the flow channel 29.

The actuator 22 has an indentation 220 which winds around the circumference such that the remaining casing 221 forms an elevation. This indentation 220, together with the elevated casing region, forms the flow channel 29. The actuator 22 therefore does not have any through-openings for the flow channel 29. FIG. 10 shows the development of the indentation 220. It has two legs 223, which preferably extend parallel to each other. The legs 223 taper towards the respective free ends thereof. The legs 223 are preferably not of equal width. Preferably, the narrow leg faces the inlet opening 120 and constricts the throughflow cross section to the maximum possible extent.

The two legs 223 are connected to each other by a web 224. The web 224 is preferably also configured to be asymmetrical, wherein it preferably forms an angle from the leg 223 at the inlet to the second leg 223 at the outlet, as can be seen in FIG. 10.

The flow channel 29 can also take other forms.

In FIG. 11, the magnet 6 is a disc magnet. It is arranged in an indentation in the end face of the actuator 22. The remaining elements of the actuator 22 are preferably identical to those in the first exemplary embodiment.

In FIG. 12, the actuator has a projection 222 which acts as a positioning aid for the definition of the zero setting, i.e. the definition relating to the “0” position mentioned at the outset, of the throttle 2.

In FIG. 13, arranged at the rear end of the housing 20 facing away from the actuator 22 is a storage element 7, an RFID tag in this case, on which data can be stored when the throttle 2 is produced, but preferably also when the throttle 2 is in operation. Preferably, at least correction data for correcting the position of the actuator 22 are stored.

The throttle unit according to the invention makes it possible to set and adjust the throttle automatically in an accurate but nevertheless cost-effective manner.

1. A throttle unit, in particular of a blow moulding device, comprising a throttle and a position sensor,
wherein the throttle has an actuator and a drive unit comprising an electric motor for changing a position of the actuator,
wherein a throughflow cross section in a throughflow channel a fluid is changeable by changing the position of the actuator,
wherein the drive unit is arranged at a first end of the actuator,
wherein
the position sensor directly monitors the position of the actuator.

2. The throttle unit according to claim 1, wherein the position sensor is arranged in a region of a second end of the actuator opposing the first end.

3. The throttle unit according to claim 2, wherein the actuator has a flow channel, through which fluid can flow, and wherein the actuator is configured to be closed at the second end relative to the flow channel.

4. The throttle unit according to claim 1, wherein the actuator has an end face at the second end, and wherein the position sensor faces this end face.

5. The throttle unit according to claim 1, wherein the first end and the second end define a longitudinal centre axis and wherein the actuator is rotatable about the longitudinal centre axis.

6. The throttle unit according to claim 1, wherein the position sensor is a magnetic field sensor, and wherein
a magnet or a magnetisable element is arranged in the throttle.

7. The throttle unit according to claim 6, wherein the magnet or magnetisable element is arranged in or at an end region of the throttle.

8. The throttle unit according to claim 1, wherein the actuator has openings and/or recesses which form the flow channel, and wherein all openings and recesses of the flow channel are arranged at a distance from the second end.

9. The throttle unit according to claim 1, wherein the actuator has a basic structure in the form of a circular cylinder comprising a winding indentation which is configured to be open to the exterior and forms the flow channel.

10. The throttle unit according to claim 9, wherein the indentation has a development which has legs and a web connecting the two legs to each other.

11. The throttle unit according to claim 10, wherein the two legs extend approximately parallel to each other.

12. The throttle unit according to claim 11, wherein the two legs extend perpendicularly to the longitudinal centre axis of the actuator.

13. The throttle unit according to claim 1, wherein the electric motor has a motor shaft which is dynamically sealed, and wherein the dynamic seal the motor shaft is the only dynamic seal for sealing the throttle relative to an outer housing which receives the throttle.

14. A device comprising the throttle unit according to claim 1 and comprising an outer housing which has the duct channel,
wherein the actuator is arranged in the duct channel,
wherein the duct channel has an inlet opening for supplying the fluid into the flow channel of the actuator and an outlet opening for guiding the fluid away from the flow channel of the actuator, and
wherein the inlet opening and the outlet opening are arranged transversely to a longitudinal centre axis of the actuator.

15. A device according to claim 14, wherein the throttle, at the end thereof remote from the actuator has a flange which acts to fix the throttle in the outer housing.

16. The throttle unit according to claim 6, wherein the magnet or the magnetisable element is arranged in the actuator.

17. The throttle unit according to claim 6, wherein the magnetic field sensor is a Hall sensor.
